(19) United States
(12) Patent Application Publication
(10) Pub. No.: US 2022/0371675 A1
(43) Pub. Date: Nov. 24, 2022

(54) BICYCLE PARKING STAND SECURING STRUCTURE

(71) Applicant: HAIDONG GU, Pomona, CA (US)

(72) Inventor: HAIDONG GU, Pomona, CA (US)

(21) Appl. No.: 17/324,107

(22) Filed: May 19, 2021

(51) Int. Cl. B62H 1/02

(52) U.S. Cl. CPC B62H 1/02

(57) ABSTRACT

A bicycle parking stand securing structure includes a parking stand, and a combination member pivoted on an end of the parking stand and haying a combination part, and a long press member. The combination part has a long bearing surface, and a middle hole and two side holes. The two side boles are disposed on two sides of the middle hole along a length direction of the long bearing surface, and distances from the two side holes to the middle hole are equal to each other. The long press member includes a main screw, two side screws, a second middle hole and two second side holes. The main screw is inserted through the second middle hole to screw into the middle hole, the two side screws are inserted through the second. side hole to screw into the two side holes, respectively.

### BACKGROUND OF THE INVENTION

### 1. Field of the invention

The present insertion relates to a technical field of bicycle accessory structure, and more particularly to a bicycle parking stand securing structure.

### 2. Description of the Related Art

A bicycle parking stand is as commonly used accessory for a bicycle, and there are two types of bicycle parking stands in market in order to meet various types of bicycles. One of the two types of bicycle parking stands is a fixed bicycle parking, stand which is fixed at the destination, so that a user can move a bicycle close to and park in the fixed bicycle parking stand. The other type of bicycle parking stand is a structure assembled on the bicycle frame and has advantage of carriable with the bicycle, convenient to operate, and simple structure. The carriable bicycle parking stand is the most commonly used type, but also has many drawbacks in use,

Please refer to FIGS. 6 to 8, which show a three-dimensional schematic view of a conventional bicycle parking stand combined with a five-way bracket of a bicycle frame,. The conventional bicycle parking stand mainly includes a parking supporter 60 and an upper press plate 70. The parking supporter 60 has an assembling base 61 pivoted at an end thereof, and the assembling base 61 has an upper assembling hole 611. The upper press plate 70 has a securing screw 71 located in a center thereof and facing the upper assembling hole 611. In order to assemble the conventional bicycle parking stand with a bicycle frame 50, the assembling base 61 is pressed against lower sides of two lower fork rods 51 of the five-way bracket of the bicycle frame 50 in a direction in which the upper assembling hole 611 faces upwardly, the upper assembling hole 611 is located between the two lower fork rods 51, and the upper press plate 70 is then abutted against upper sides of the two lower fork rods 51 correspondingly in position to the assembling base 61, and the securing screw 71 is downwardly screwed with the upper assembling hole 611, so that the upper press plate 70 and the assembling base 61 are forced to be relatively close to each other to clamp tightly and secure with the two lower fork rods 51.

However, because only single securing screw 71 is inserted through and assembled with in the center of the upper press plate 70, the upper press plate 70 may be affected to be deflected along an outer diameter of the securing screw 71 by the tightening operation of the securing screw 71, and it causes the upper press plate 70 to misalign with the assembling base 61, as shown in FIG. 8. As a result, the assembling base 61 and the upper press plate 70 are unable to accurately form an uniform clamp on the upper and lower sides of the two lower fork rods 51, and the assembling base 61 of the mounted parking supporter 60 may be easily inclined because the parking supporter 60 is applied by an excessive swing force when being downwardly extended to support on the ground or being upwardly folded, and it causes that the parking supporter 60 fails to provide stable support for parking.

### SUMMARY OF THE INVENTION

An objective of the present invention is to provide a structure to strong reinforce assembly of a parking stand and a bicycle frame, so as to prevent the parking stand from being deflected or loosened when the parking stand is applied by an excessive swing force when bema downwardly extended to support on the ground or being upwardly folded, thereby providing stable support for parking.

In order to achieve aforementioned objective and effect, the present invention provides a bicycle parking stand securing structure including a parking stand, a combination member, and a long press member. The combination member is pivoted at an end of the parking stand and having a combination part. The combination part has a long bearing surface, a middle hole and two side holes cut through the long bearing surface, the two side holes are disposed on two sides of the middle hole and collinearly arranged in a straight line with the middle hole alone a length direction of the long bearing surface and distances from centers of the two side holes to a center of the middle hole are equal to each other. The long press member includes, along a length direction, a main screw, two side screws arranged, a second middle hole corresponding in position to the middle hole, and two second side boles corresponding in position to the two side holes. he main screw is inserted through and assembled with the second middle hole, to screw into the middle hole, the two side screws are inserted through and assembled with, the second side holes to screw into the two side holes, respectively, wherein the main screw and the two side screws are screwed toward a screwing direction to force the long press member to move close to the long bearing surface.

### BRIEF DESCRIPTION OF THE DRAWINGS

The structure, operating principle and effects of the present invention will be described in detail by way of various embodiments which are illustrated in the accompanying drawings.

FIG. 1 is a perspective assembly view of a bicycle parking stand securing structure of the present invention.

FIG. 2 is a perspective exploded view showing an operation of mounting a bicycle parking stand securing structure of the present invention with a bicycle. frame.

FIG. 3 is a perspective assembly view of a bicycle parking stand securing structure of the present invention mounted with a bicycle frame.

FIG. 4 is a plan view of a bicycle parking stand securing structure of the present invention mounted with a bicycle frame, when viewed from a top view angle.

FIG. 5 is a schematic cross-sectional view taken along V-V of FIG. 3.

FIG. 6 is a perspective exploded view showing an operation of mounting a conventional securing structure with a bicycle frame.

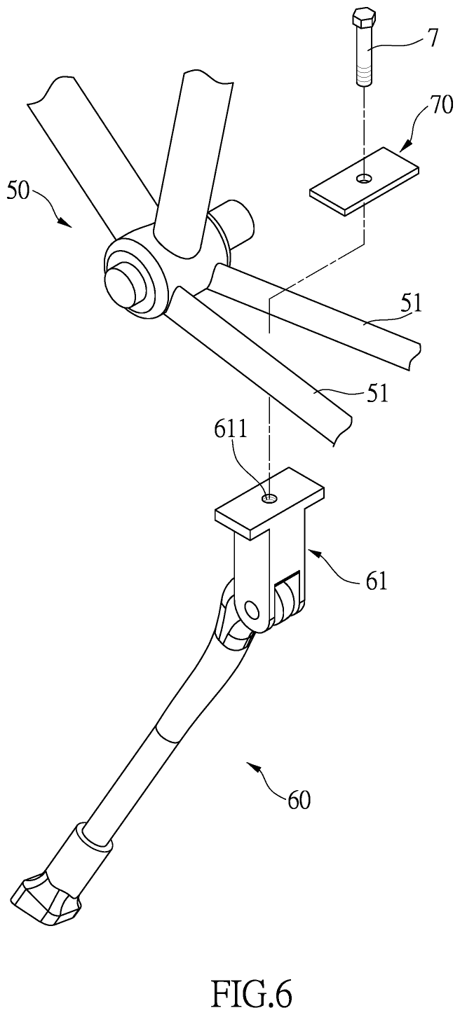

FIG. 7 is a perspective assembly view of a conventional securing structure mounted with a bicycle frame.

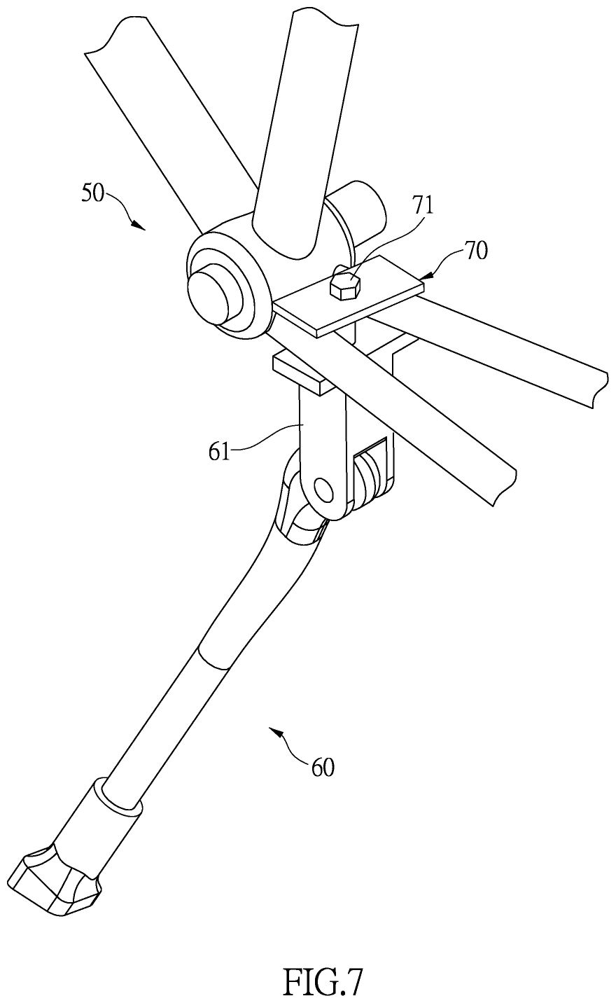

FIG. 8 is a schematic assembly plan view of a conventional securing structure mounted with a bicycle frame.

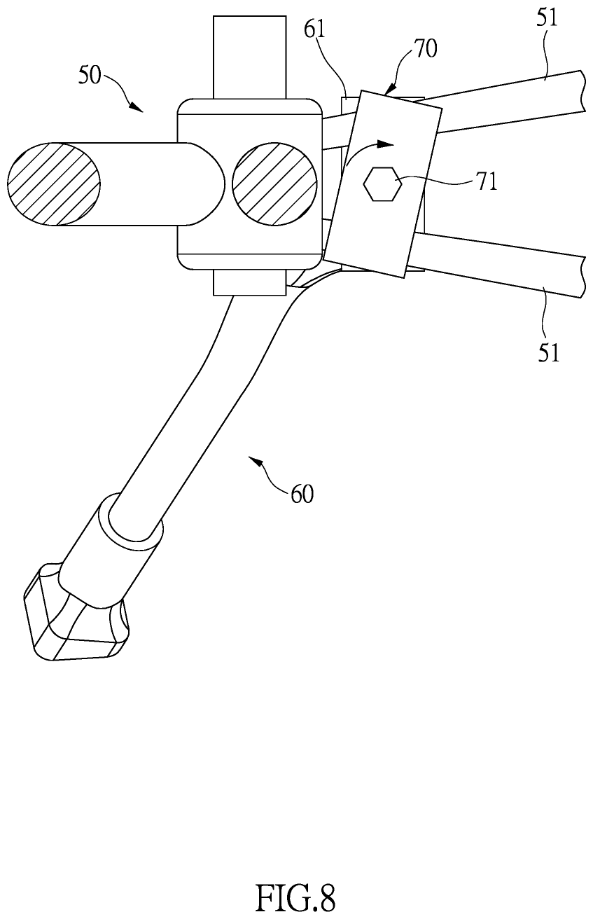

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

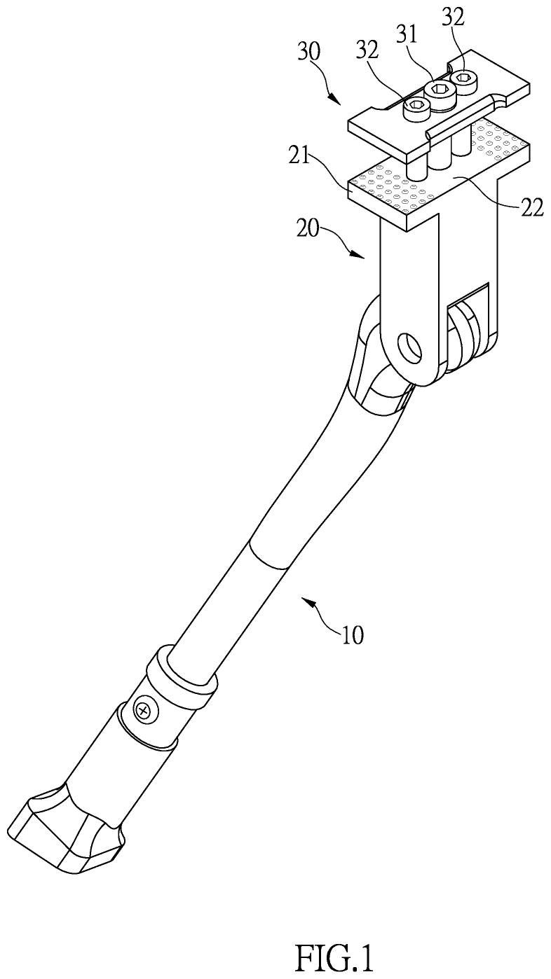

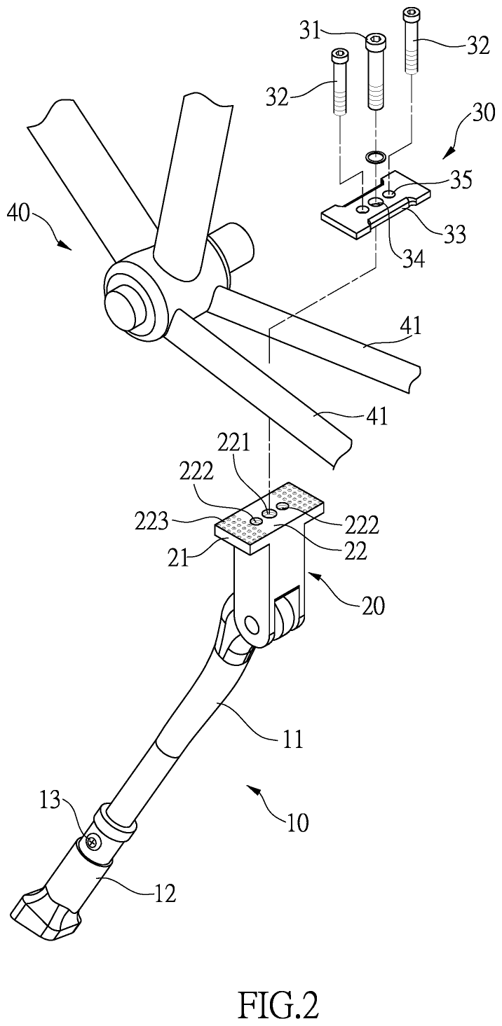

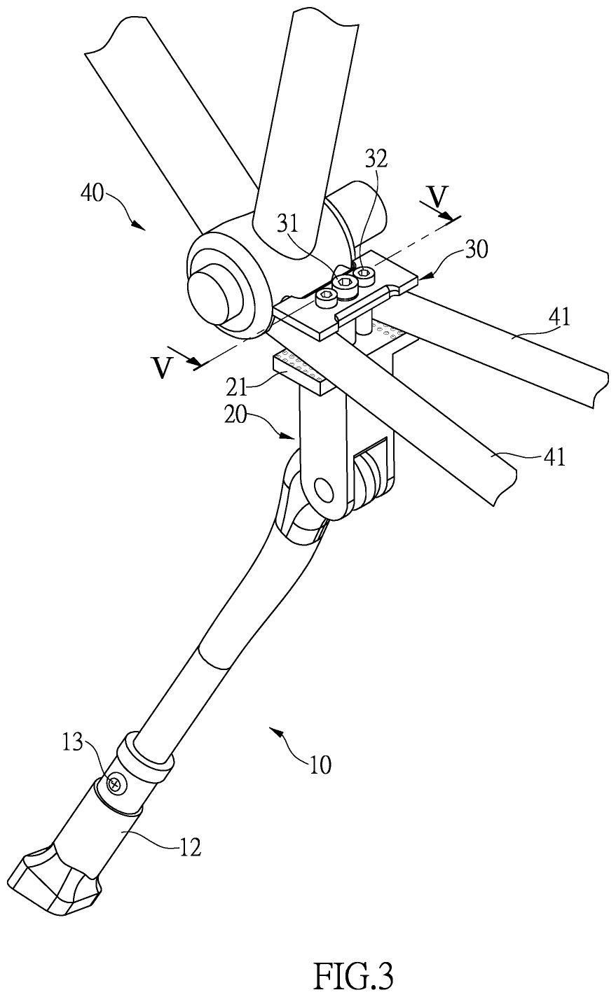

Please refer to FIGS. 1 to 5, the present invention provides a bicycle parking stand securing structure including a parking stand 10, combination member 20 and a long press member 30.

The combination member 20 is pivoted on an end of the parking stand 10 and has a combination part 21, and the combination part 21 has a long bearing surface 22, and a middle hole 221 and two side holes 222 cut through the long bearing surface 22. The two side holes 222 are disposed on two sides of the middle hole 221, and collinearly arranged with the middle hole 221 in interval along a length direction of the long bearing surface 22, and the distances from centers of the two side holes 222 to a center of the middle hole 221 are equal to each other.

The long press member 30 includes a main screw 31 and two side screws 32, a second middle hole 34 disposed correspondingly in position to the middle hole 221, and two second side holes 35 disposed correspondingly in position to the two side holes 222. The main screw 31, the two side screws 32, the second middle hole 34 and the two second side holes 35 are arranged along a length direction of the long press member 30. The main screw 31 is inserted through and assembled with the second middle hole 34 to screw with the middle hole 221, and the two side screws 32 are inserted through and assembled with the two second side hole 35 to screw with the two side holes 222, respectively. Thee main screw 31 and the two side screws 32 are screwed toward a screwing direction to force the long press member 30 to move close to the long bearing surface 22, and the two side screws 32 are two-side-symmetrically abutted against the long press member 30.

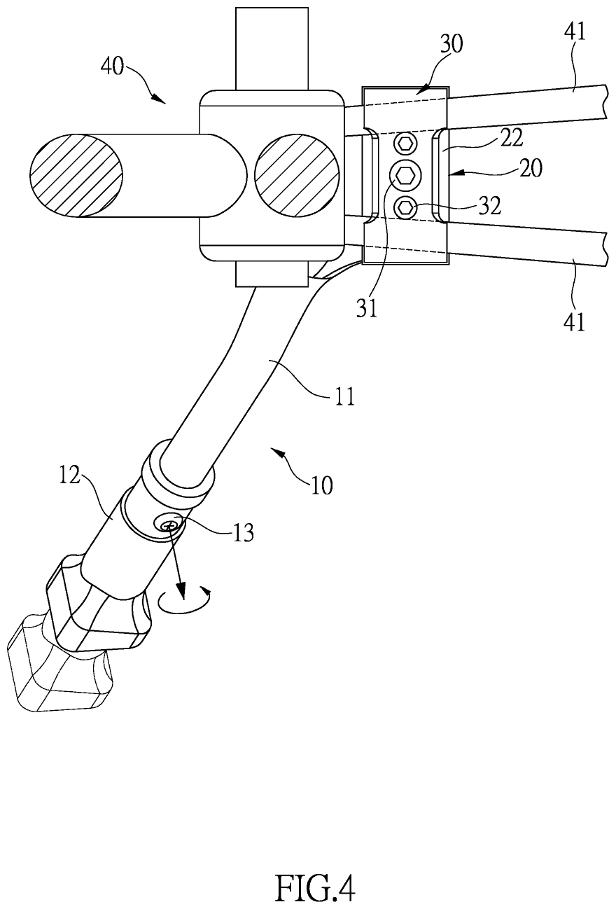

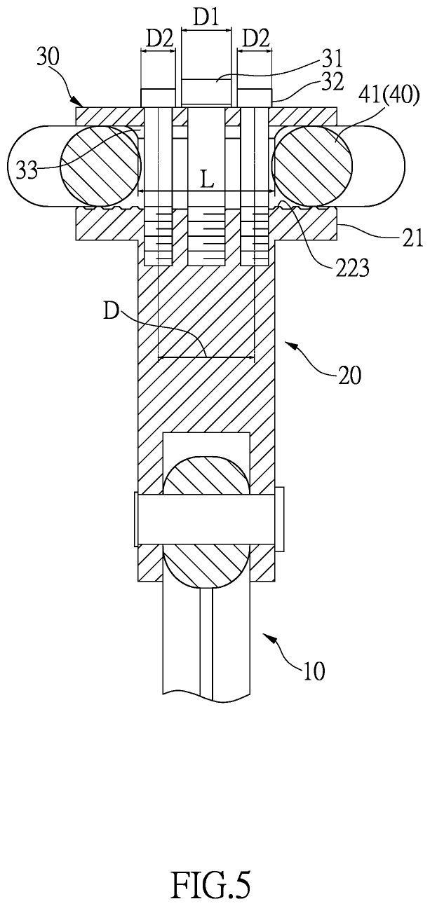

According to aforementioned descriptions, in order to mount the bicycle parking stand securing structure of the present invention with a bicycle frame 40, the long bearing surface 22 on the combination part 21 of the combination member 20 at the upper end of the parking stand 10 can be abutted against lower sides of two lower fork rods 41 of a five-way bracket of the bicycle frame 40, and the long bearing surface 22 below the two lower fork rods 41 is adjusted to make the middle hole 221 and the two side holes 222 are located between the two lower fork rods 41; next, the main screw 31 is inserted through and assembled with the second middle hole 34, to screw into the middle hole 221; the side screws 32 are inserted through and assembled with the second side holes 35, to screw into the two side holes 222, respectively, so as to support the long press member 30 and prevent the long press member 30 from being deflected, as shown in FIGS. 4 and 5. With the configuration of the long press member 30 and the long bearing surface 22 not being deflected relative to each other, the two side screws 32 can apply a symmetrical reinforcement packing force on the long press member 30, so that when the long press member 30 is approached to the long bearing surface 22, the long press member 30 and the long bearing surface 22 are forced to clamp the two lower fork rods 41 by a two-side-symmetrical reinforce clamp force, to prevent the combination member 20 from being deflected or loosened by an excessive swing force when the parking stand 10 is downwardly extended to support on the ground or is upwardly folded. As a result, the bicycle parking stand securing structure of the present invention is able to provide stable support for parking.

Features of members of the bicycle parking stand securing structure of the present invention are described in detail in the following paragraphs. As shown in Figs. 1 to 5, a sum of a screw head diameter D1 of the main screw 31 and a screw head diameter D2 of one of side screw 32 is lower than a distance D between the two side holes 222, so as to prevent a screw head of the main screw 31 from being interfered and impacted with a screw head of any one of the two side screws 32.

Furthermore, a diameter of each side screw 32 can be equal to or lower than that of the main screw 31, the two side screws 32 can apply symmetrical forces with respect to the main screw 31, so as to pressure the long press member 30 to achieve the firmer tightly-clamping effect.

The long bearing surface 22 has a plurality of friction protrusions 223 disposed thereon and arranged in interval, and when the two lower fork rods 41 of the bicycle frame 40 are clamped by the long bearing surface 22 and the long press member 30, the plurality of friction protrusions 223 can apply better clamping and securing effect on the lower fork rods 41.

As shown in FIG. 5, the long press member 30 can have two lower folding plates 33 downwardly extended from the two sides of the second middle hole 34 and the two second side holes 35, and a length L of each lower folding plate 33 is greater than a maximum distance between the two second side holes 35, a bending resistance length of each of the two lower folding plates 33 formed on the long press member 30 can exceed a maximum distance between the two side screws 32 screwed in the two second side holes 3S, so that the two lower folding plates 33 can reinforce the long press member 30 to resist the pressing force of the two side screws 32.

In an embodiment, the parking stand 10 includes a main support post 11, and a sliding support post 12 mounted with the main support post 11. The support post 12 has a locating assembly 13 disposed on a side thereof, the sliding support post 12 is slidable on the main support post 11 to adjust a telescopic length of the parking stand 10, and after the telescopic length is adjusted, the locating assembly 13 can be tightly fastened; as shown by solid lines and dashed lines in FIG. 4; after the locating assembly 13 is loosened along an arrow direction shown in FIG. 4, the sliding support post 12 can be slid relative to the main support post 11, so as to adjust the telescopic length of the parking stand 10, and after adjustment of the telescopic length is completed, the locating assembly 13 can be locked tightly for securing, in a direction opposite to the shown arrow, so that the parking stand 10 can be adjusted correspondingly to different height of the bicycle frame 40, to achieve a wide range of flexibility.

According to above-described contents of the present invention, the two side screws 32 screwed at two sides of the main screw 31 can prevent the long press member 30 and the long bearing surface 22 from being deflected with respect to each other; with the configuration of the long press member 30 and the long bearing surface 22 not being deflected with respect to each other, the problem that the combination member may be deflected by an excessive swing force when the parking stand 10 is downwardly extended to support with the ground or is upwardly folded can be solved. The bicycle parking stand securing structure of the present invention has the following advantages.

First, the two side screws 32 can apply symmetrical reinforcement packing force on the long press member 30 at the two sides of the main screw 31, to pressure the long press member 30 to clamp the two lower fork rods 41 with respect to the long bearing surface 22, so as to form the two-side-symmetrical reinforcement securing clamp.

Secondly, the bicycle parking stand securing structure of the present invention can firmly clamp the bicycle frame 40 for mounting, so as to provide stable support for parking.

The present invention disclosed herein has been described by means of specific embodiments. However, numerous modifications, variations and enhancements can be made thereto by those skilled in the art without departing from the spirit and scope of the disclosure set forth in the claims,

What is claimed is:

1. A bicycle parking stand securing structure, comprising:
a parking stand;
a combination member pivoted at an end, of the parking stand and having a combination part, wherein the combination part has a long bearing surface, a middle hole and two side holes cut through the long bearing surface, the two side holes are disposed on two sides of the middle hole and collinearly arranged in a straight line with the middle hole along a length direction of the long hearing surface, and distances from centers of the two side holes to a center of the middle hole are equal to each other; and
a long press member comprising, along a length direction, a main screw, two side screws arranged, a second middle hole corresponding in position to the middle hole, and two second side holes corresponding in position to the two side holes, wherein the main screw is inserted through and assembled with the second middle hole, to screw into the middle hole, the two side screws are inserted through and assembled with the second side holes to screw into the two side holes, respectively, wherein the main screw and the two side screws are screwed toward a screwing direction to force the long press member to move close to the long bearing surface.

2. The bicycle parking stand seeming structure according to claim 1 wherein a sum of a screw head diameter of the main screw and a screw head diameter of one of the side screw is lower than a distance between the two side holes, so that a screw head of the main screw is not interfered and impacted with a screw head of any one of the two side screws.

3. The bicycle parking stand securing structure according to claim 1 wherein a diameter of each of the two side screws is equal to or lower than that of the main screw.

4. The bicycle parking stand securing structure according to claim 1, wherein the long bearing surface has a plurality of friction protrusions disposed thereon and arranged in interval.

5. The bicycle parking stand securing structure according to claim 1, wherein the long press member comprises two lower folding plates downward extended from the second middle hole and two second side holes, and a length of each of the lower folding plates is greater than a maximum distance between the two second side holes.

6. The bicycle parking stand securing structure according to claim 1, wherein the parking stand comprises a main support post, and a sliding support post mounted with the main support post, wherein the sliding support post has a locating assembly disposed on a side thereof and slidable on the main support post to adjust a telescopic length, so as to tightly secure the locating assembly.
